(19) United States
(12) Patent Application Publication
(10) Pub. No.: US 2008/0136333 A1
(43) Pub. Date: Jun. 12, 2008

(54) IR automatic sensor lamp camera

(76) Inventor: David Fang, Taipei (TW)

Correspondence Address: BIRCH STEWART KOLASCH & BIRCH, PO BOX 747, FALLS CHURCH, VA, 22040-0747, US

(21) Appl. No.: 11/979,606

(22) Filed: Nov. 6, 2007

(30) Foreign Application Priority Data
Nov. 8, 2006 (TW) 095219717

(51) Int. Cl. H05B 37/02

(52) U.S. Cl. 315/149

(57) ABSTRACT

The present invention relates to a kind of IR automatic sensor lamp camera. Different from the IR camera having the same function in the market, this invention is to improve the IR camera and place the camera inside the sensor for the use of IR LED and camera together and with the appearance of one body formation. Presently the IR LED and camera PCB of IR camera has shorter operating life due to the heat generated during long hours of operation. In general the IR cameras are installed inside aluminum housing and the IR LED operates at least 14 hours a day. In contrast, the temperature generated by the IR LED inside the aluminum housing will lower the operating life of infrared and camera PCB. The principle of improvement is to further combine the IR projector with the passive IR sensor and camera PCB.

### FIELD OF THE INVENTION

The present invention relates to a kind of sensor lamp camera, and more particularly to a kind of IR automatic sensor lamp camera.

### BACKGROUND OF THE INVENTION

The existing IR cameras are all made of aluminum in square or round shape. In addition to IR LED, camera PCB, and power supply circuit inside the camera, there is a set of optical sensor control circuit. The IR projector does not give out light if there is enough light in the environment. However, when the light in the environment is below a value, the IR projector will emit IR light all the time to assist the lighting for camera PCB. Therefore, if the temperature generated in the housing cannot be properly dissipated due to the IR LED, leading to the reduced operating life of camera PCB or increased cost because of the additional heat dissipation device. Also, the continuous operating of IR LCD will also increase power consumption. Hence, more cost will incur in the subsequent days of operation. Looking at over ten years in the past, IR camera is at an indispensable position in the monitor system. Now that the application is getting popular, other problems still remain unsolved.

In view of the many drawbacks mentioned above, the purpose of this new intention is to improve the existing problems of IR camera to perfection and upgrade its quality.

### SUMMARY OF THE INVENTION

The main purpose of this invention is in providing a kind of IR automatic sensor lamp camera, through the design of a traditional IR camera a breakthrough innovation is designed into its application. The IR LED's are formed using several tens to a hundred of LED subassembly are formed in different angles into a fixed angle and area or using visible light source of different attributes for the light source projection assisting camera to achieve the light compensating effect; then to combine with the passive IR sensor and IR power supply driver module could allow the IR LED and camera PCB to have longer operating life and when used at night could save more energy; and also could change the IR LED module into visible light source for presenting color screen so as to exemplify the concept this innovation should have as a whole in order to upgrade the feature of the IR camera. Only through the design of such innovation can the current problem of low operating life and high power usage be overcome. The above stated is the spirit of this new invention.

Below is a further description through the embodiment together with the attached diagrams that could better understand the purpose of the present invention, the technical content, features, and the effect it could achieve.

### BRIEF DESCRIPTION OF THE DRAWINGS

FIG. 1 is the 3D illustration of the assembly of the front of the present invention.

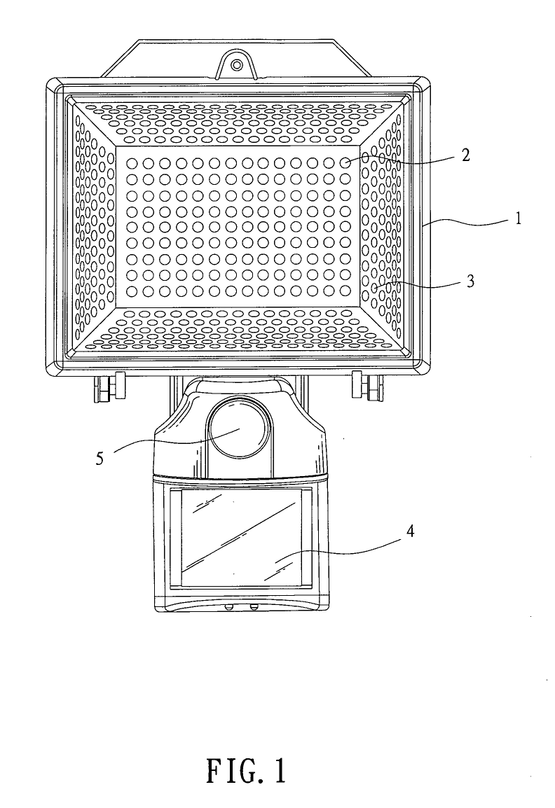

FIG. 2 is the 3D illustration of the assembly of the rear of the present invention.

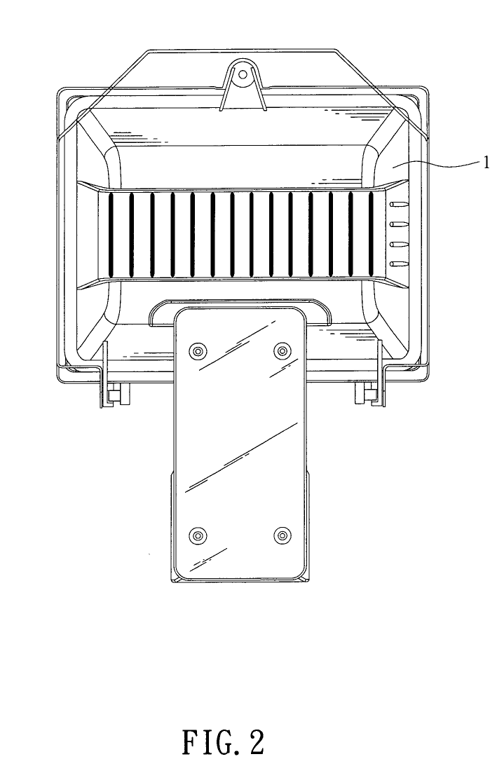

FIG. 3 is the exploded illustration of the lamp of the present invention.

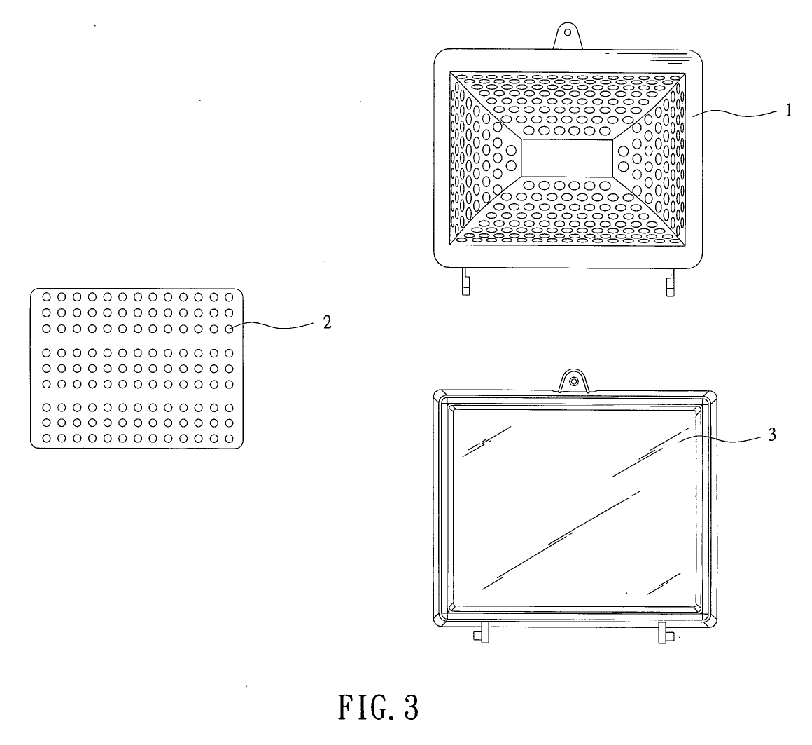

FIG. 4 is the 3D illustration of the IR sensor of the present invention.

FIG. 5 is the exploded illustration of the interior of the camera cavity of the present invention.

FIG. 6 is the exploded illustration of the connecting wire box of the present invention.

### DETAILED DESCRIPTION OF THE PREFERRED EMBODIMENTS

In order for the auditing committee to better understand the detail of the IR automatic sensor camera, please refer to the attached diagrams for the description as shown below:

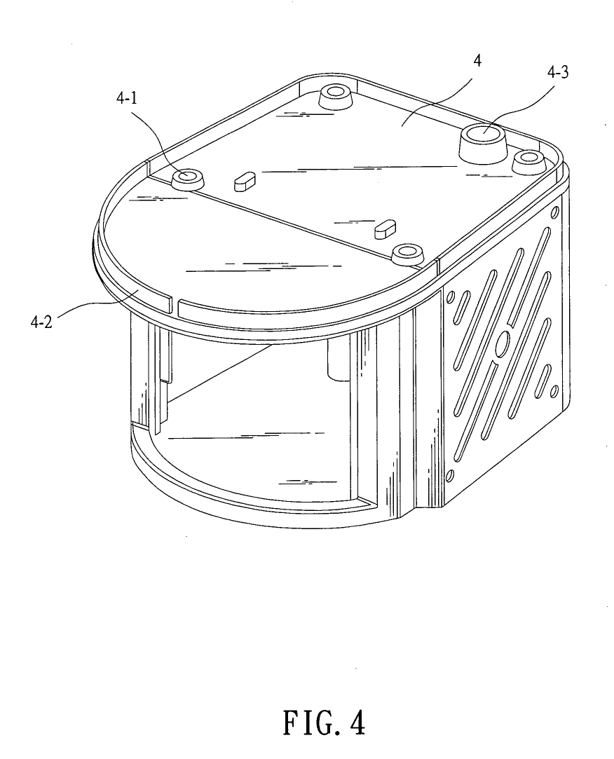

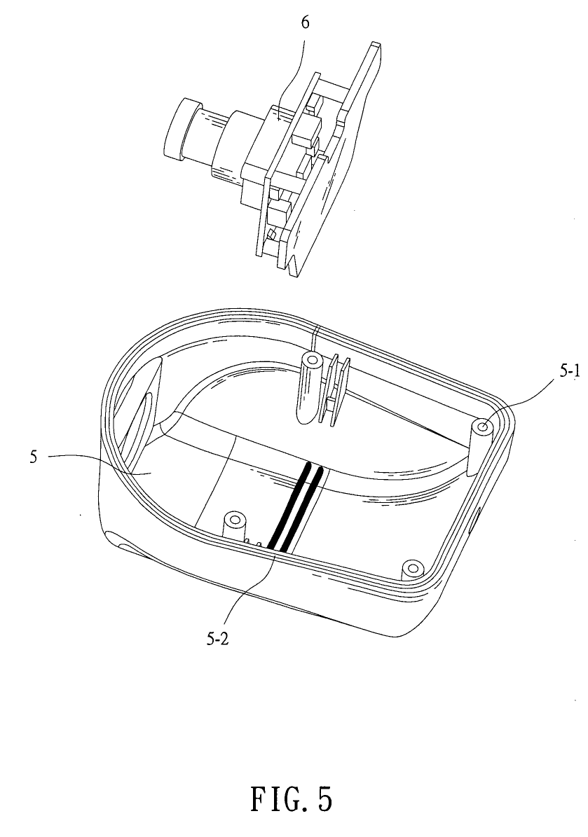

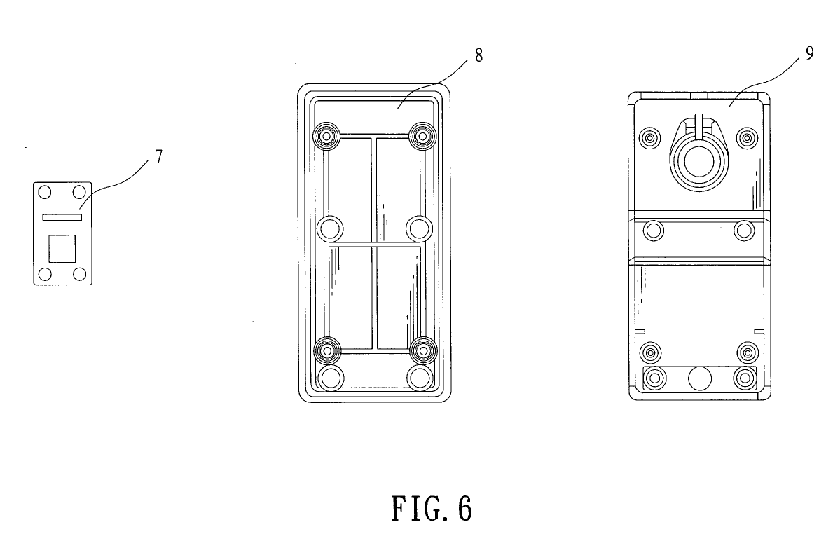

Please also refer to the first diagram, which is the 3D illustration of the front of the assembly of this invention, and the third diagram, which is the exploded illustration of the lamp of this invention. As shown in the diagram, an IR LED module (2) is installed inside the lamp housing (1) and connected to the said lamp (1) through a mirror lamp frame (3) for the protection of IR LED module (2); the power lead cable of the IR LED module (2), refer to the FIG. 6, goes through the connecting wire box (9) and connects to the output terminal of the passive IR sensor (4) (refer to the FIG. 4) in providing the driving power of IR LED module (2); the passive IR sensor (4) itself has the function of setting action time and adjustment of action time for the control of IR LED module (2); the power leading cable of the camera PCB supporting module (6) (refer to the FIG. 5) goes to the power driving module (7) (refer to the FIG. 4) through the entrance of the rear wire hole (4-3) of the passive IR sensor providing the power for the camera PCB supporting module (6) (refer to the FIG. 5); the screw fixing rod (5-1) inside the camera cavity and the depressed slot (5-2) along the peripheral edge of the camera (refer to the FIG. 5) is connected to the screw hole (4-1) of the passive IR sensor and the protruding slot (4-2) at the top of the passive IR sensor (refer to FIG. 4); the power driving module (7) installed inside the connecting wire box (9) (refer to the FIG. 6) is connected to the input terminal of the passive IR sensor (4) (refer to the FIG. 4) as the driving power of the passive IR sensor (4); the bottom casing (8) of the connecting wire box is covered on the connecting wire box (9) (refer to the FIG. 6) for the protection of power driving module (7), where the optical source module of different attributes can be an IR LED module, an alkaline lamp, or a white light LED module. The inside of a camera cavity is installed with several screw fixing rods connecting to the several screw holes at the top of the passive IR sensor, where the front outside the said camera cavity is installed with a viewing round hole of a camera lens that can be used for the action of taking pictures, and the peripheral of the said camera is a depressing slot type that can be connected to the protruding slot of the said passive IR sensor; the wire of the output terminal of a power driving module is connected to the input terminal of the said passive IR sensor, and the said power driving module, the said passive IR sensor, and the said lamp are formed in one body with the installation of the said camera.

The current new innovation of IR automatic sensor lamp camera has wide application. It can be installed in every corner of a building such as corridor, staircase, arcade, or road junction in public place where camera monitoring is required. The wavelength of IR is between 850 nm and 940 nm. Such wavelength lies in the light spectrum invisible to human eyes. Together with the professional camera PCB, the camera can achieve the hidden effect at night. And the IR LED module can also be converted into visible light source at night showing color screen. During daylight, the automatic sensor projector will not project IR light source and at night the passive IR sensor will be used for sensing. When people pass by, the automatic IR projector will provide the necessary assistant lighting.

The main purpose of the IR automatic sensor lamp camera, in addition to the effective projecting, is to achieve the function of saving power, increase operating life, and at the same time assist the camera in compensating light. Therefore, the combination of passive IR sensor makes the overall usage better meets the economic benefit and increase the practical usability, which is the spirit of this innovation.

In summary, this invention to breakthrough the prior technology and has indeed achieve the intended effectiveness and is also not easy for people mastering the art to think of. In addition, this invention has never been announced previously. Its advances and practicality obviously meet the requirement of application of innovative patent. I hereby propose this invention application and appreciate your committee would approve this patent application for the encouragement of invention.

What is claimed is:

1. A kind of IR automatic sensor lamp camera, which includes:
An IR LED module, an alkaline lamp tube, or a white lamp LED module installed inside a lamp, with features of light source module of different attribute connected with a power cable connected to the output terminal of a passive IR sensor.

2. The IR automatic sensor lamp camera stated in claim 1, with features of the output terminal of a power-driving module is connected to the output terminal of a passive IR sensor.

3. The IR automatic sensor lamp camera stated in claim 2 above with features of a power supply of the OCB supporting module of a camera connected to the output terminal of the PCB support module of the said camera.

4. The IR automatic sensor lamp camera stated in claim 1 of the claim with features of the interior of the camera cavity is installed with several screws fixing rod combined with several screw holes on the top of the said passive IR sensor, where the front on outside of the camera cavity is installed with a outside viewing round hole for a camera lens.

5. The IR automatic sensor lamp camera stated in claim 1 above, with feature of several fixing screw rods installed inside a camera cavity is connected to several screw holes at the top of the said passive IR sensor, where the front outside the said camera cavity is installed with a camera lens viewing round hole.

6. The IR automatic sensor lamp camera stated in claims 1, with features of the said power supply driving module, the said passive IR sensor, and the said lamp are formed in one body with the installation of the said camera.
